(19) United States
(12) Patent Application Publication
(10) Pub. No.: US 2017/0230264 A1
(43) Pub. Date: Aug. 10, 2017

(54) METHOD AND APPARATUS FOR POWER AMPLIFIER STABILITY TEST

(71) Applicant: THOMSON LICENSING, Issy-les Moulineaux (FR)

(72) Inventors: William D. Woodward, Lilburn, GA (US); William Kevin Kay, Duluth, GA (US); William T. Murphy, Lawrenceville, GA (US)

(21) Appl. No.: 15/420,597

(22) Filed: Jan. 31, 2017

Related U.S. Application Data
(60) Provisional application No. 62/293,049, filed on Feb. 9, 2016.

(51) Int. Cl. H04L 12/26; H04L 29/06; H04W 24/04

(52) U.S. Cl. CPC H04L 43/0823; H04W 24/04; H04L 43/16; H04L 65/1023; H04W 84/12

(57) ABSTRACT

A method for testing a power amplifier assembled in a gateway connected to a service provider network includes remotely testing the radio of the gateway. The method configures the gateway to perform a first baseline receive noise measurement and compare it to a second receiver noise measurement. The power amplifier is determined to be in a fault condition if the second receiver noise measurement is greater than the baseline receiver noise measurement.

### CROSS REFERENCE TO RELATED APPLICATIONS

This application claims priority from U.S. Provisional Application Ser. No. 62/293,049, filed on 9 Feb. 2016, the entire contents of which are incorporated herein by reference in their entirety for all purposes.

### FIELD

The present invention relates to remote testing, specifically, the remote testing of RF power amplifiers in gateways and the like located in a business or home environment.

### BACKGROUND

Gateways are devices installed in businesses or homes to distribute services that are offered by service providers. Such services can include, but are not limited to, internet access via Ethernet cable or wireless connection, and access to subscription services, such as cable TV or movies on demand, digital telephone services, and the like. The gateway, if located in a home or business, is instrumental in providing such services via a local network downstream of the gateway. That is, the gateway drives the local network, such as a home network, to provide the above-mentioned services. As such, gateway operation is critical to the proper functionality of the service distribution in the local home network. The gateway is just one part of customer premise equipment (CPE).

As sometimes occurs in mass produced consumer electronics, errors in the electronics assembly can occur due to part failures over time. Such failures may include manufacturing errors, part application design errors, and the like. Some failures may not be apparent to the end-user. The expense of sending trained service provider technicians to troubleshoot problems can be daunting to the service provider if the error is determined to be an error in the gateway equipment itself. In such an instance a home or business visit to the site of the deployed equipment may be necessary to test and then repair or replace the gateway. Thus, a method to easily detect errors in gateways is needed.

### SUMMARY

This summary is provided to introduce a selection of concepts in a simplified form as a prelude to the more detailed description that is presented later. The summary is not intended to identify key or essential features of the invention, nor is it intended to delineate the scope of the claimed subject matter.

In one aspect of the invention, a method for testing a power amplifier of an electronic device connected to a network includes tuning a radio of an electronic device to a frequency range. A receive/transmit switch is configured such that an output of the power amplifier is connected to an antenna of the electronic device. A low noise amplifier is placed to an on state, the low noise amplifier having an output connected to the radio, wherein an input to the low noise amplifier is not connected to the antenna. The radio conducts a baseline receive noise measurement. The power amplifier is then placed to an on state, wherein the power amplifier is not driven with an input signal for transmission. The radio conducts a second receiver noise measurement. The baseline receiver noise measurement is compared with the second receiver noise measurement. The power amplifier is determined to be in a fault condition if the second receiver noise measurement is greater than the baseline receiver noise measurement. One fault condition is an oscillation of the power amplifier.

The determination that the power amplifier is in a fault condition if the second receiver noise measurement is greater than the baseline receiver noise measurement includes determining if the second receiver noise measurement is greater than the baseline receiver noise measurement by a threshold amount. The detection method is repeated for multiple frequency ranges of a possible oscillation fault. Also, the detection method is conducted for one of many amplifier chains of a multiple amplifier device of the radio of the electronic device. The tuning of a radio of an electronic device includes tuning one of a gateway and a set-top box via commands sent via the network.

In one embodiment, the above method is performed by a controller of service provider equipment. Recording of the baseline receiver noise measurement and the second receiver noise measurement is performed in the controller. In another embodiment, the method is performed by the device under test itself. The results of which are sent to a service provider as required.

In an embodiment, an apparatus for testing a power amplifier of an electronic device connected to a network includes, a network interface for sending commands across the network. The apparatus also includes a processor, connected to a memory, which functions to control the network interface to conduct remote testing of a power amplifier in an electronic device. The power amplifier of the electronic device is determined to be in a fault condition if a receiver noise level measurement, taken when the power amplifier is enabled without an input signal, is greater than a baseline receiver noise level measurement. One possible fault condition is a power amplifier oscillation fault.

In the above apparatus embodiment, the baseline noise level measurement is taken when the power amplifier is in an off state. The baseline noise level measurement is taken after a low noise amplifier is placed in an enabled state but not typically connected to an antenna.

In another embodiment, the apparatus further has a wireless interface for use in a portable or mobile configuration. In another embodiment, the apparatus is a controller of service provider equipment. Alternately, the electronic device under test is one of a gateway and a set-top box.

Additional features and advantages of the invention will be made apparent from the following detailed description of illustrative embodiments which proceeds with reference to the accompanying figures. The drawings are provided for purposes of illustrating the concepts of the disclosure and is not necessarily the only possible configuration for illustrating the disclosure.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention. In the drawings, like numbers represent similar elements.

FIG. 1 illustrates an example environment in which the current invention may be practiced;

FIG. 2 depicts a gateway device deployed in a business or home environment;

FIG. 3 depicts an example gateway device block diagram;

FIG. 4 depicts an example power amplifier configuration used in a gateway device;

FIG. 5 depicts an example method to remotely test a gateway device in a business or home environment; and

FIG. 6 illustrates an example access point controller device.

### DETAILED DISCUSSION OF THE EMBODIMENTS

In the following description of various illustrative embodiments, reference is made to the accompanying drawings, which form a part thereof, and in which is shown, by way of illustration, how various embodiments in the invention may be practiced. It is to be understood that other embodiments may be utilized and structural and functional modification may be made without departing from the scope of the present invention.

The determination of possible faults in service provider equipment located at the customer premises, such as gateways provided by the service provider may be accomplished remotely. The service provider can distribute services to the customer premises, such as a business or home environment via a Wide Area Network (WAN), such as a cable network. According to an aspect of the present disclosure, the same WAN network interface to the customer premises may be used to communicate with the devices, such as gateways, to determine if such devices are functioning properly.

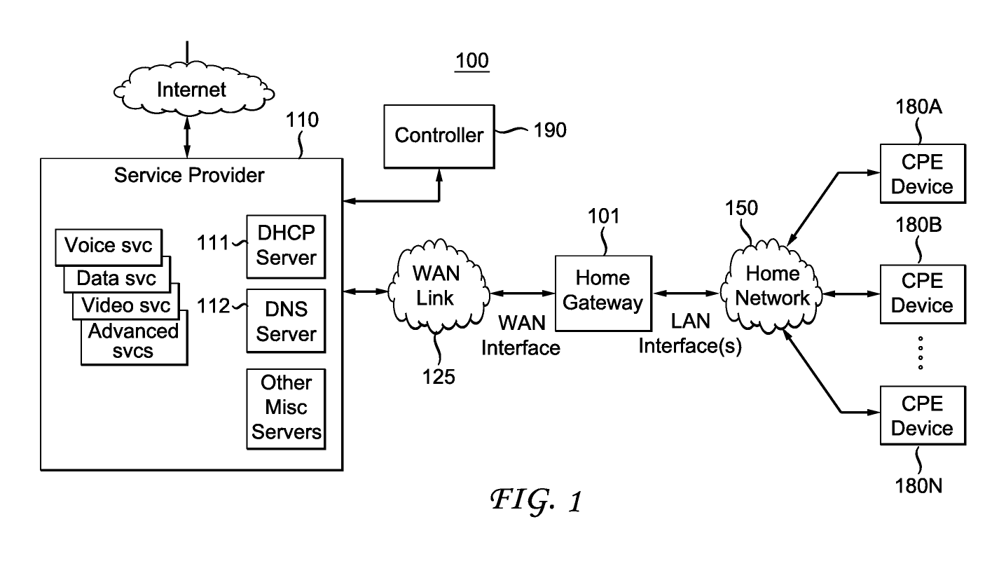

FIG. 1 illustrates a system 100 which serves as an example environment for the present invention. In the example environment, a home network distribution is shown. However, a business or academic environment is also contemplated. FIG. 1, a block diagram of a typical arrangement for a networking communication system 100 according to aspects of the present disclosure, is shown. According to an exemplary embodiment, home gateway 101 is an advanced cable gateway, cable modem, DSL modem or the like, and is coupled to a wide area network (WAN) link 125 through a WAN interface to service provider 110. The WAN link 125 may be any one or more of the possible communication links including, but not limited to, coaxial cable, fiber optic cable, telephone line, or over the air links. The home gateway 101 is also coupled via a local area network (LAN) interface to home network 150 which couples one or more customer premises equipment (CPE) devices 180A-N. The home network 150 preferably includes a wireless link (not shown in FIG. 1) but may also include wired links such as co-axial cable or Ethernet. CPE devices 180A-N may include, for example, personal computers, network printers, digital set-top boxes, and/or audio/visual media servers and players, among others.

Service provider 110 provides one or more services, such as voice, data, video and/or various advanced services, over WAN link 125 to CPE devices 180 through home gateway 101 and LAN interface 150. Service provider 110 may include internet related services and server structures such as a DHCP server 111 and DNS server 112, and may include other servers and services as well (e.g., video on demand, news, weather). It is important to note that these servers and services can be co-located or widely distributed, physically and/or virtually, in both hardware and software. It is contemplated that service provider 110 operates in a conventional manner in accordance with well-known protocols. In an illustrative cable application, service provider 110 may be, for example, a cable multiple service operator (MSO).

Home gateway 101 acts as the interface between the WAN link 125 external to the customer's home and the home network 150 located in the customer's home. Home gateway 101 converts transport data packets, such as packets in an IP protocol, from a format used in the WAN to a format used in the home network or LAN. Home gateway 101 also routes data packets, including the converted data packets between the WAN and one or more devices on the home network. Home gateway 101 may include interfaces for both wired networking (e.g., Ethernet or Multimedia over Coaxial Cable Alliance (MoCA)) and wireless networking. Home Gateway 101 allows data, voice, video and audio communication between the WAN and CPE devices 180A-N used in the customer's home, such as analog telephones, televisions, computers, and the like. Likewise, gateway 101 can have wireless interface to customer WiFi devices (not shown in FIG. 1).

In one aspect of the invention, Controller 190 can be used by the service provider to send status interrogation commands to the gateway 101 via the WAN interface to the gateway 101. Gateway 101 can respond via the WAN interface of the gateway 101 and provide the needed status information, such as operational state and fault indications. Although controller 190 is shown as a separate device connected to the service provider, such a controller may be an integral part of the service provider equipment. The service provider equipment is also collectively termed the headend. Alternately, controller 190 can be linked to the service provider equipment via an interface remote to the service provider equipment 110. For example, controller 190 may be connected to service provider 110 via the internet connection to the service provider equipment 110. Alternately, the controller may be connected to the WAN link 125. As such, the controller 190 may be co-located with the service provider equipment 110. Alternately, controller 190 may be a portable unit, such as a hand-held device that is taken close to or inside the location where the home gateway is deployed. As such, controller 190 is contemplated to be an instance of hand-held equipment that is used by service provider technicians outside or inside the home or business environment where the gateway is located.

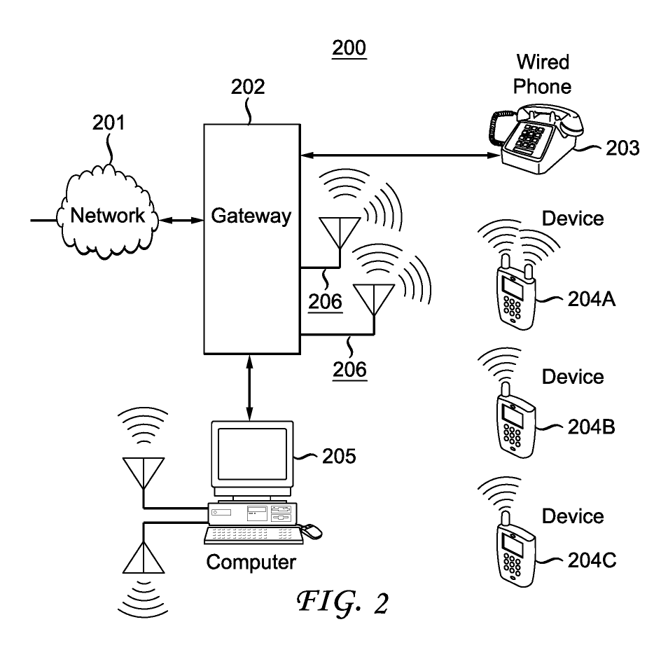

Turning to FIG. 2, an embodiment of a gateway system 200 according to aspects of the present disclosure is shown. Gateway system 200 operates in a manner similar to networking communication system 100 described in FIG. 1. In gateway system 200, network 201 is coupled to gateway 202. Gateway 202 connects to wired phone 203. Gateway 202 also connects to computer 205. In addition, gateway 202 interfaces with devices 204A-204C through a wireless interface using one or more antennas 206. Alternatively, Gateway 202 may also interface with computer 205 using the one or more antennas 206.

In particular, gateway system 200 operates as part of a cable or DSL communication network and acts to interface a packet data cable system or DSL network to one or more home networks. Gateway System 200 includes a gateway 202 that provides the interface between the network 201, operating as a WAN, and the home network(s). Gateway system 200 also includes wired analog telephone device 203 capable of operating as a home telephone when connected through gateway 202. In addition, gateway 202 also acts to provide a radio frequency (RF) interface to multiple wireless devices 204A, 204B, and 204C. Wireless device 204A, 204B, and 204C are handheld devices that operate at frequencies above 1.7 GHz, typically, 2.4 GHz or 5.0 GHz using wireless packet transmissions via one or more antennas 206 on gateway 202. In other embodiments, other devices with wireless interfaces including, but not limited to routers, tablets, set-top boxes, televisions, and media players may be used.

The wireless interface included in gateway 202 may also accommodate one or more wireless formats including Wi-Fi, Institute of Electrical and Electronics Engineers standard IEEE 802.11 or other similar wireless communication protocols. Further, it is important to note that each antenna in the system may be attached to a separate transceiver circuit. As shown in FIG. 2, gateway 202 includes two transceiver circuits and two antennas. Device 204A and computer 205 also include two transceiver circuits and two antennas while device 204B and device 204C include only one transmit receive circuit and one antenna. In some alternate designs it may be possible that more than one antenna may be included with, and used by, a single transceiver circuit.

In operation, gateway 202 provides internet protocol (IP) services (e.g., data, voice, video, and/or audio) between devices 204A-C and internet destinations identified and connected via network 201. Gateway 202 also provides IP voice services between wired phone 203 and call destinations routed through network 201. Gateway 202 further provides connectivity to a local computer 205 either via a wired connection such as is shown in FIG. 2 or via a wireless connection through one or more antennas and transceiver circuits. Thus, example interfaces for computer 205 include Ethernet and IEEE 802.11.

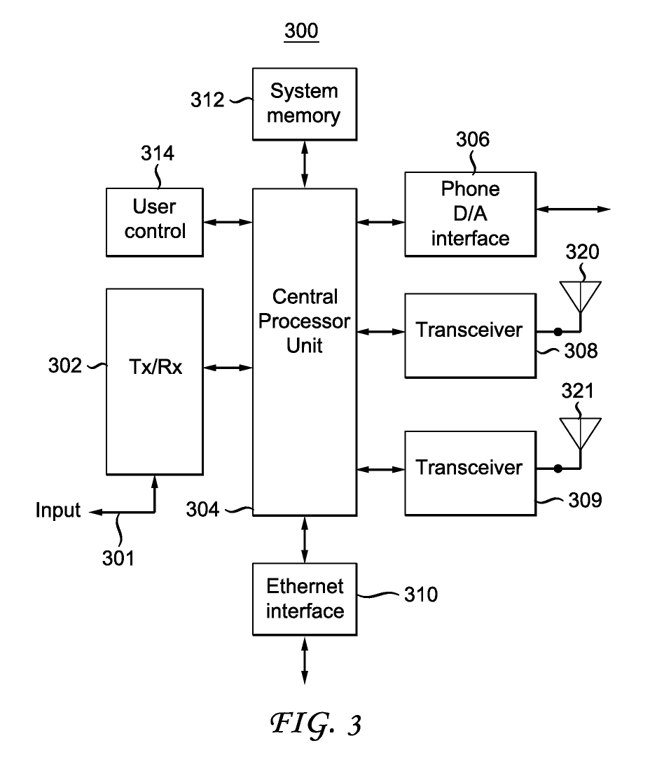

Turning to FIG. 3, a block diagram of an exemplary gateway device 300 according to aspects of the present disclosure is shown. Gateway device 300 may correspond to gateway 202 described in FIG. 2 or to home gateway 101 described in FIG. 1. In gateway device 300, an input signal is provided to RF input 301. RF input 301 connects to tuner 302. Tuner 302 connects to central processor unit 304. Central processor unit 304 connects to phone digital-to-analog (D/A) interface 306, transceiver 308, transceiver 309, Ethernet interface 310, system memory 312, and user control 314. Transceiver 308 further connects to antenna 320. Transceiver 309 further connects to antenna 321. It is important to note that several components and interconnections necessary for complete operation of gateway device 300 are not shown in the interest of conciseness, as the components not shown are well known to those skilled in the art. Gateway device 300 may can operate as an interface to a cable or DSL communication network and further may can provide an interface to one or more devices connected through either a wired, optical, or wireless home network.

A signal, such as a cable or DSL signal on the WAN, is interfaced to a transmit/receive (Tx/Rx) block 302 through RF input 301. Tuner 302 performs RF modulation functions on a signal provided to the WAN and demodulation functions on a signal received from the WAN. The RF modulation and demodulation functions are the same as those commonly used in communication systems, such as cable or DSL systems. Central processor unit 304 accepts the demodulated cable or DSL signals and digitally processes the signal from tuner 302 to provide voice signals and data for the interfaces in gateway 300. Similarly, central processor unit 304 also processes and directs any voice signals and data received from any of the interfaces in gateway 300 for delivery to tuner 302 and transmission to the WAN.

System memory 312 supports the processing and IP functions in central processor unit 304 and serves as storage for program and data information. Processed and/or stored digital data from central processor unit 304 is available for transfer to and from Ethernet interface 310. Ethernet interface may support a typical Registered Jack type RJ-45 physical interface connector or other standard interface connector and allow connection to an external local computer. Processed and/or stored digital data from central processor unit 304 is also available for digital to analog conversion in interface 306. Interface 306 allows connection to an analog telephone handset. Typically, this physical connection is provided via an RJ-11 standard interface, but other interface standards may be used. Processed and/or stored digital data from central processor unit 304 is additionally available for exchange with transceiver 308 and transceiver 309. Transceiver 308 and transceiver 309 can both support multiple operations and networked devices simultaneously. Central processor unit 304 is also operative to receive and process user input signals provided via a user control interface 314, which may include a display and/or a user input device such as a hand-held remote control and/or other type of user input device.

It is important to note that devices employing multiple antennas and in some cases multiple transceivers or transmit/receive circuits, such as the cable or DSL gateways described above or other networking devices, may operate in a number of transmit and receive modes. In one mode, only one antenna (and one transceiver circuit) is used for both transmission and reception, known as single input single output (SISO) mode. In a second mode, only one antenna is used for transmission and more than one antenna (using one or more transceiver circuits) may be used for reception, known as multiple input single output (MISO) mode. In a third mode, more than one antenna (using one or more transceiver circuits) may be used for transmission while only one antenna is used for reception, known as single input multiple output (SIMO) mode. Finally, more than one antenna (using one or more transceiver circuits) may be used for transmission and reception, known as multiple input multiple output (MIMO) mode. The present embodiments are intended to address issues found in any one of these modes.

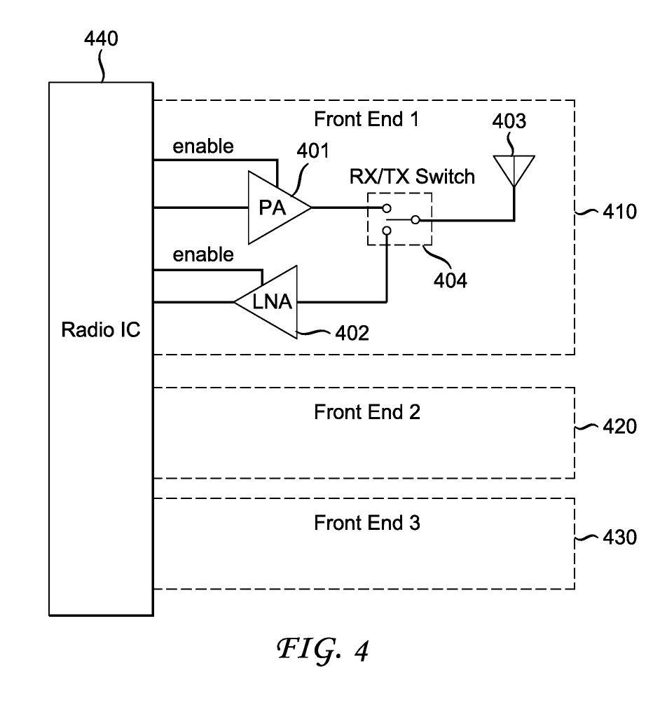

FIG. 4 shows one embodiment of transceivers 308 and/or 309 of FIG. 3. The depiction of FIG. 4 illustrates a radio integrated circuit (IC) 440 that can operate in a MIMO mode. FIG. 4 depicts a 3×3 MIMO radio configuration. In one application of the present disclosure, it is postulated that a fault in one of more of the Power Amplifier (PA) 401 of the configuration of FIG. 4 is desired to be detected. In one fault mode, the Power Amplifiers could be oscillating causing spurious operation or reduced performance Such spurious operation may result in the generation of undesirable RF outputs. Such spurious operation can result in unwanted radiated emissions or conducted emissions; either of which can adversely affect the performance of the gateway where the power amplifiers reside. In such an event, the present disclosure acts to test the gateway performance without removing the gateway from the deployed home or business environment.

Returning to FIG. 4, in one application of the disclosure, where a 3×3 MIMO is present, the three front end circuits 410, 420, 430 are identical including power amplifiers, low noise amplifiers, RX/TX switches, and antennas. Under normal operating conditions the radio IC 440 enables all three front end circuits 410, 420, 430 identically. That is, all three are either in receive mode or transmit mode at the same time. The RX/TX switch 404 in each front end is controlled by the Radio IC 440 (control lines not shown). Normally, the Radio IC 440 can be configured remotely via controller 190 of FIG. 1. In FIG. 4, to enable receive mode, the LNA (Low Noise Amplifier) 402 enable line is set true and the RX/TX Switch 404 is configured such that the antenna 403 is connected to the LNA 402 input. This allows the radio to receive three signals from the three antennas of front ends 410, 420, and 430 simultaneously. Note that the antennas are part of the gateway; either internal or external. In transmit mode, the PA (power amplifier) 401 is enabled and the RX/TX switch 404 is configured such that the output of the PA 401 is connected to the antenna 403 allowing the radio to transmit three signals simultaneously. That is, a transmission can occur from the PAs in each of front ends 410, 420, and 430 simultaneously in transmit mode. In one aspect of the present disclosure, the radio IC 440 presented in FIG. 4 can be configured in multiple ways. Also, basic performance measurements, such as noise measurements, may be conducted by testing configurations of the Radio IC 440 using remote commands from controller 190.

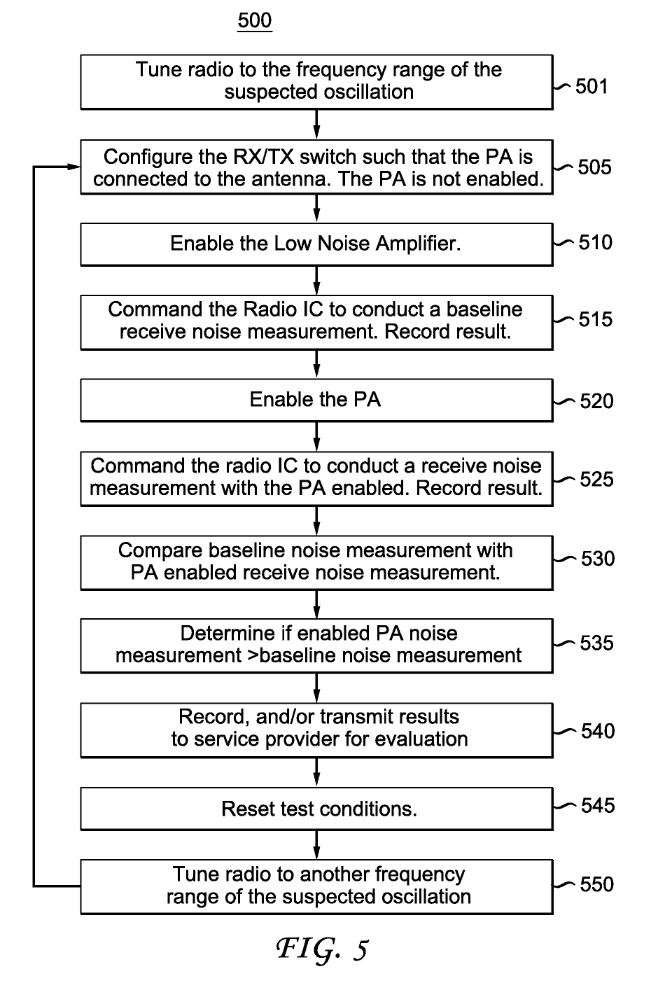

FIG. 5 depicts a method according to the present disclosure that is used to test for a power amplifier (PA) that has fault condition in one of the front ends 410, 420, or 430. In one type of failure mode, the PA produces a spurious frequency output, such as in an oscillation. In an example failure mode or fault condition, the radio IC 440 is still functional but has reduced performance and interfering outputs. Commands may be sent to an electronic device, such as a gateway or set-top box under test, remotely via controller 190 commands or commands generated via the gateway under test, such as gateway 202 or 300 of FIGS. 2 and 3 respectively. Initially, the LNA 402 and PA 401 of front-end 410 of FIG. 4 are turned off (not enabled). At step 501 of FIG. 5, the radio IC 440 is tuned to the frequency range of the suspected oscillation. This frequency range may exceed the normal operation of the receiver in the radio IC 440. At step 505, the RX/TX switch 404 of front end 410 of FIG. 4 is switched such that the PA 401 is connected to the antenna 403 via the RX/TX switch 404. The PA 401 output is terminated but the PA is not enabled. Note that the RX/TX switch 404 is down-stream of the PA 401. Step 510 enables (turns on) the Low Noise Amplifier (LNA) 402 of front-end 410 of FIG. 4.

At step 515, the radio IC 440 is commanded to make a first receive noise measurement on front end 1. This first measurement provides a baseline receive noise measurement at the tuned frequency. Note that the PA 401 not enabled. This baseline noise measurement can be stored for later comparison or sent to the controller 190. Note that the LNA 402 is not connected to the antenna 403 for the baseline noise measurement.

At step 520, the PA 401 in front end 410 is enabled (turned on), but the PA 401 is not driven with an input signal for transmission. At step 525 the radio IC 440 is commanded to make a second receive noise measurement. The noise that is measured at step 525 is largely the noise of the PA 401 output reduced by the isolation of RX/TX switch 404. This second noise measurement may be termed the PA-enabled noise measurement. Note that the LNA 402 is still not connected to the antenna 403. This second receive noise measurement, termed PA-enabled noise measurement can also be stored for later comparison or sent to the controller 190.

At step 530 the baseline receiver noise measurement is compared to the PA-enabled receiver noise measurement. This comparison may be conducted at the service provider headend equipment, such as by the controller 190. In an alternative embodiment, the gateway under test (such as 101, 202, and 300) can perform the comparison and transfer the results to the controller 190. At step 535, it is determined if the PA-enabled receiver noise measurement taken in step 525 is greater than the baseline receiver noise measurement taken in step 515. Significantly, if the power amplifier is oscillating, the PA-enabled noise measurement taken at step 525 will be greater than the baseline noise measurement taken at step 515. The comparison may be made such that detection of an oscillating PA may require that the step 525 PA-enabled receiver noise measurement be greater than the baseline step 515 receiver noise measurement by a margin. The margin may be considered a threshold that is determined based on the characteristics of the specific amplifiers involved. The threshold can be determined experimentally as is well known by one of skill in the art. Note that steps 530 and 535 may be combined or performed separately. In one embodiment, steps 530 and 535 are performed at the headend controller 190. In another embodiment, the gateway under test (such as 101, 202, and 300) can perform steps 530 and 535.

In either event, the results of the comparison are recorded for immediate or future transmittal back to the service provider equipment 110 at step 540 for evaluation. Step 540 may be optional because the data taking at steps 515 and 525 may be made and transferred to the controller 190 for processing later. At step 545, the initial test conditions for the PA oscillation detection may be reset as needed. At step 550, a different frequency is selected for tuning to perform a receiver noise measurement at another frequency as required to measure the entire frequency range of the suspected oscillations on a selected PA or a PA within the same front-end if there are multiple PAs in one front end.

Steps 501 through 545 are repeated for each front end chain of the configuration represented by FIG. 4 with the possible modification noted above for data collection for later evaluation. Thus, in one embodiment, the steps 530 and 535 are performed after a set of noise measurement data for a PA is recorded in the controller 190. The controller or other service provider equipment can then perform the comparison and evaluation of steps 530 and 535. The gateway under test (such as 101, 202, and 300) can also perform steps 530 and 535 if the data is stored in the gateway instead of the controller 190. One aspect of the evaluation of the results of step 535 is that receiver noise measurements of a Low Noise amplifier (LNA) are used to determine if a power amplifier (PA) is oscillating. The method of FIG. 5 may be terminated when all the frequency ranges of a suspected PA oscillation are tested with corresponding receiver noise measurements.

As mentioned above, steps 501 through 545 are repeated for each front end chain (410, 420, 430) of the configuration of FIG. 4. The steps 530 and 535 are performed after a set of noise measurement data for a PA is recorded in the controller 190. The controller or other service provider equipment can then perform the comparison and evaluation of steps 530 and 535. In one embodiment, where it is determined that one of the front end chains of the Radio IC 440 is oscillating or in a fault condition, the controller 190 or other service provider equipment can send a command to the Radio Controller 440 to turn off or otherwise disable the front end chain that is determined to be oscillating or in a fault condition. This can leave the remaining front end chains operational. This fault isolation technique allows the electronic device under test to operate within regulatory specification until a repair could be performed (or the unit replaced).

Another embodiment of the disclosure is to allow performance of the steps of FIG. 5 to be directed as a self-test by the gateway or set-top box (device under test). In this embodiment, instructions for the method of FIG. 5 can be loaded into the gateway or set-top box and executed by the device under test either by request from a network command or internally within the device under test. The results of testing, either partial or completely can be kept within the device under test or can be sent to service provider equipment (headend) as needed.

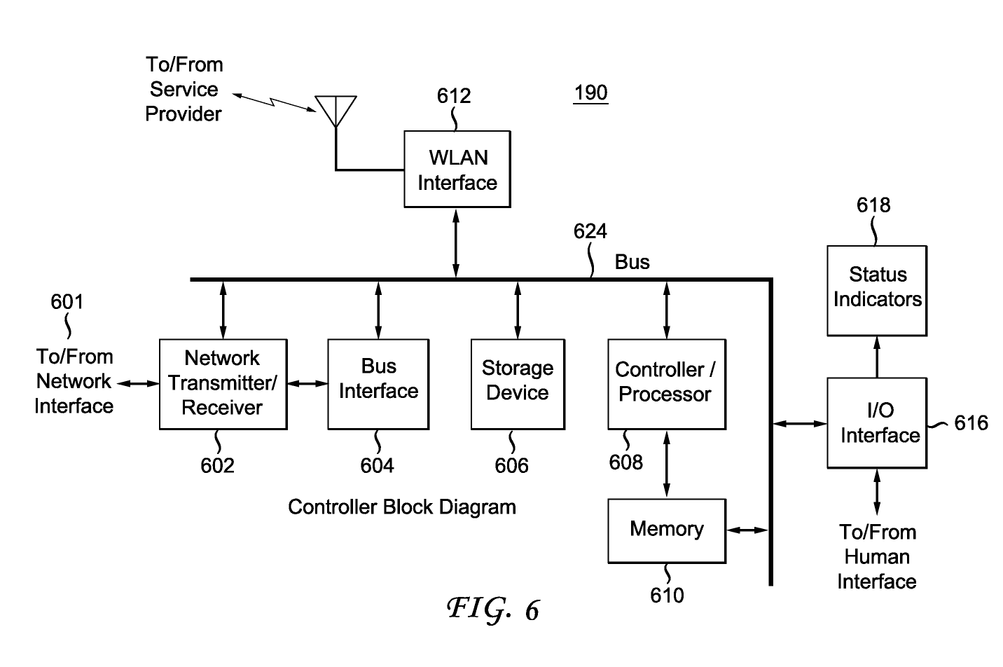

FIG. 6 provides a block diagram of a controller device, such as device 190 of FIG. 1. It is noted that the controller device may be a device connected to the WAN of FIG. 1, connected to or part of the service provider 110 as shown in FIG. 1, or the controller of FIG. 6 may be a stand-alone mobile device used by service technicians either outside or inside the business or home environment. Thus, the controller device 190 can be either a part of the service provider equipment, such as item 110 of FIG. 1, or a portable or mobile device to be used near the deployment area of the gateway under test. If used as a mobile device, the measurements taken can be either stored in the controller memory or sent to the service provider or both for subsequent processing.

The controller of FIG. 6 includes a controller processor 608 having access to memory 610 configured on a bus 624 to access resources such as local storage 606, I/O interfaces 616, a WLAN interface 612, and a bus interface 604 for the network transceiver 602. The WLAN interface 612 may be optional and can be used as a wireless interface to communicate with external equipment, such as other service provider equipment. The WLAN interface may be useful for IEEE 802.11 interfaces or even cellular telephone interfaces to allow the controller 190 to communicate with service provider equipment (not shown) that can program and access the controller or local storage to assist in performing the method of FIG. 5. The WLAN interface may be optional and may be used in a portable or wireless version of the controller as previously discussed. In a portable or mobile configuration, the controller 190 may have a human compatible interface connected to I/O interface 616 such as a display screen and an input function such as soft or hard keys, or a mouse. Status indicators 618 can include a text screen, LED displays, and the like.

The network interface 601 which feeds the network transceiver can be the WAN 125 connection (connection not shown in FIG. 1). Alternately, the network interface may be the connection to the service provider equipment 110 as shown in FIG. 1. Data for configuration, programming to perform the method of FIG. 5, and/or the transmission of acquired data to the service provider may occur via the network interface 601. In an alternate embodiment, controller 190 may be an embedded function residing in the service provider equipment 110.

This disclosure also contemplates other approaches to address the problem of detecting electronic device (i.e. Gateway, STB, and the like) faults remotely. Specifically, to detect an oscillation problem, the above-discussed method of comparing receiver noise measurements under different conditions may have alternative solutions. One such solution is to use other sensors in the radio integrated circuit to detect an anomaly. One such sensor is a temperate sensor. Temperature sensors may provide an indirect indication of a fault which can cause a temperature rise or fall in the case of anomalous operation. For this solution, the temperature sensors should ideally have enough sensitivity to provide well-informed diagnostics based on normal versus abnormal operation. Another solution to the remote detection of a power amplifier oscillation condition would be to use a different receiver chain of the radio integrated circuit (or a different radio receiver IC) to sense the generation of oscillation harmonics that are present in the faulty power amplifier chain but not present on the receiver chain that is being used to detect the oscillation harmonics. Using a receiver chain that is spatially distinct from a faulty power amplifier chain may also be useful to detect a fault. The above two alternative detection schemes remain viable in certain conditions.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus, hardware and software apparatus. An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random access memory (“RAM”), a read-only memory (“ROM”) or any other magnetic, optical, or solid state media. The instructions may form an application program tangibly embodied on a computer-readable medium such as any of the media listed above or known to those of skill in the art. The instructions thus stored are useful to execute elements of hardware and software to perform the steps of the method described herein.

1. A method for testing a power amplifier of an electronic device connected to a network, the method comprising:
tuning a radio of an electronic device to a frequency range;
configuring a receive/transmit switch such that an output of the power amplifier is connected to an antenna of the electronic device;
enabling a low noise amplifier to an on state, the low noise amplifier having an output connected to the radio, wherein an input to the low noise amplifier is not connected to the antenna;
conducting a baseline receive noise measurement;
enabling the power amplifier to an on state, wherein the power amplifier is not driven with an input signal for transmission;
conducting a second receiver noise measurement;
comparing the baseline receiver noise measurement with the second receiver noise measurement; and
determining that the power amplifier is in a fault condition if the second receiver noise measurement is greater than the baseline receiver noise measurement.

2. The method of claim 1, wherein determining that the power amplifier is in a fault condition comprises determining if the power amplifier is oscillating.

3. The method of claim 1, wherein determining that the power amplifier is in a fault condition if the second receiver noise measurement is greater than the baseline receiver noise measurement comprises determining if the second receiver noise measurement if greater than the baseline receiver noise measurement by a threshold amount.

4. The method of claim 1, wherein tuning a radio comprises tuning the radio of the electronic device to a frequency range of a suspected power amplifier oscillation.

5. The method of claim 1, wherein the method is repeated for multiple frequency ranges.

6. The method of claim 1, wherein the method is conducted for all of a plurality of amplifier chains of a multiple amplifier device of the radio of the electronic device.

7. The method of claim 6, wherein the power amplifier that is in a fault condition is commanded to be in an off state.

8. The method of claim 1, wherein tuning a radio of an electronic device comprises tuning one of a gateway and a set-top box via commands sent via the network.

9. The method of claim 1, wherein the method is performed by a controller by sending commands to the electronic device over the network.

10. The method of claim 9, further comprising recording the baseline receiver noise measurement and the second receiver noise measurement in the controller.

11. The method of claim 1, wherein the method is performed by a gateway or set-top box.

12. An apparatus for testing a power amplifier of an electronic device connected to a network, the apparatus comprising:
a network interface for sending commands across the network;
a processor, connected to memory, that functions to control the network interface to conduct testing of a power amplifier in an electronic device;
wherein the power amplifier of the electronic device is determined to be in a fault condition if a receiver noise level measurement, taken when the power amplifier is enabled without an input signal, is greater than a baseline receiver noise level measurement.

13. The apparatus of claim 12, wherein the fault condition is an oscillation of the power amplifier.

14. The apparatus of claim 12, wherein the baseline noise level measurement is taken when the power amplifier is in an off state.

15. The apparatus of claim 12, wherein the baseline noise level measurement is taken after a low noise amplifier is placed in an enabled state but not connected to an antenna.

16. The apparatus of claim 12, further comprising a wireless interface for use in a portable or mobile configuration.

17. The apparatus of claim 12, wherein the apparatus is a controller of service provider equipment.

18. The apparatus of claim 12, wherein the electronic device is one of a gateway and a set-top box.

19. The apparatus of claim 12, wherein the processor turns off the power amplifier upon determining that the power amplifier is in a fault condition.
